(19) United States
(12) Patent Application Publication
(10) Pub. No.: US 2025/0297772 A1
(43) Pub. Date: Sep. 25, 2025

(54) CERAMIC HEATER AND LIQUID HEATING DEVICE

(71) Applicant: Niterra Co., Ltd., Nagoya-shi (JP)

(72) Inventor: Hiroki HATTORI, Nagoya-shi (JP)

(73) Assignee: Niterra Co., Ltd., Nagoya-shi (JP)

(21) Appl. No.: 19/053,701

(22) Filed: Feb. 14, 2025

(30) Foreign Application Priority Data
Mar. 19, 2024 (JP) 2024-043168
Oct. 16, 2024 (JP) 2024-180510

(51) Int. Cl. F24H 1/10; F24H 9/00

(52) U.S. Cl. CPC F24H 1/102; F24H 9/0005; F24H 2250/02

(57) ABSTRACT

A ceramic heater 100 for liquid heating, including: a columnar ceramic body 10 extending in an axial-line O direction and including a heat generation resistor element 13; and a heat radiation fin 20 which protrudes from a surface of the ceramic body and is higher in thermal conductivity than the ceramic body, wherein the heat radiation fin extends in the axial-line direction.

### BACKGROUND

### 1. Field of the Disclosure

The present disclosure relates to a ceramic heater for liquid heating and a liquid heating device which are used for air conditioning of, for example, an electric vehicle, heating and temperature keeping of a battery, or the like.

### 2. Description of Related Art

There has been studied a system in which a medium such as a coolant liquid is heated with a ceramic heater for air conditioning of an electric vehicle or heating and temperature keeping of a battery. In particular, since the performance of the battery decreases in cold regions, heating and temperature keeping of the battery are important.

Such a ceramic heater has a structure in which a ceramic layer is wound around the outer periphery of a tubular or columnar ceramic tube serving as a core, and a heat generation resistor element having a predetermined heater pattern is formed in the ceramic layer (see Patent Document 1). When electricity is supplied to the heat generation resistor element, the ceramic heater generates heat.

There has also been known a technique of improving the warm air generation characteristics of an air heater by attaching heat radiation fins to the outer surface of a ceramic heater (see Patent Document 2).
[Patent Document 1] Japanese Patent Application Laid-Open (kokai) No. 2019-133762
[Patent Document 2] Japanese Patent Application Laid-Open (kokai) No. H2-94384

However, the heater described in Patent Document 2 is an air heater, and the flow of liquid around the heater is not considered. Therefore, when the air heater is used for heating a liquid, the efficiency in heating the liquid can be improved, but depending on the relation between the flow direction of the liquid around the heater and the direction in which the heat radiation fins extend, the flow of the liquid around the heater is hindered.

### SUMMARY OF THE DISCLOSURE

Accordingly, an object of the present disclosure is to provide a ceramic heater and a liquid heating device which can improve heating efficiency without hindering the flow of a liquid to be heated.

### Means for Solving the Problem

In order to solve the above problem, a ceramic heater of the present disclosure is a ceramic heater for liquid heating, the ceramic heater having: a columnar ceramic body extending in an axial-line direction and including a heat generation resistor element; and a heat radiation fin which protrudes from a surface of the ceramic body, and is higher in thermal conductivity than the ceramic body, wherein the heat radiation fin extends in the axial-line direction.

According to this ceramic heater, the heat radiation fin extends in the axial-line direction. Hence, when the ceramic heater is disposed in the internal space of the container in such a manner that the flow direction has an inclination angle of less than 45 degrees with respect to the axial-line direction, the flow direction of the liquid around the ceramic heater approximately coincides with the direction in which the heat radiation fin extends (=the axial-line direction). Thus, the liquid flows smoothly along the heat radiation fin without resistance. Therefore, it is possible to improve the efficiency in heating the liquid to be heated, without hindering the flow of the liquid.

In the ceramic heater of the present disclosure, a plurality of the heat radiation fins may be disposed such that they are separated from one another in a circumferential direction of the ceramic body.

With this ceramic heater, since the heat radiation fin has a plurality of fin portions, the efficiency in heating the liquid to be heated can be further improved.

A liquid heating device of the present disclosure is a liquid heating device having: a container having an internal space and having an inlet and an outlet which communicate with the internal space; and a ceramic heater of the present disclosure, which extends in the axial-line direction, and in which the heat generation resistor element is located in the internal space, wherein, in a flow path through which a liquid introduced from the inlet flows through the internal space to the outlet, the liquid is heated by the ceramic heater, the heat radiation fin faces at least a portion of the flow path, and when a portion of the flow path which the heat radiation fin faces is defined as a target flow path, a flow direction of the liquid in the target flow path has an inclination angle of less than 45 degrees with respect to the axial-line direction.

According to this liquid heating device, since the flow direction in the target flow path in the container approximately coincides with the direction in which the heat radiation fin extends (=the axial-line direction). Thus, the liquid flows smoothly along the heat radiation fin without resistance. Therefore, it is possible to improve the efficiency in heating the liquid to be heated, without hindering the flow of the liquid.

In the liquid heating device of the present disclosure, the ceramic body may have a through hole along the axial-line direction, the through hole may communicate, through its one end, with the inlet and may face the internal space through its other end, the flow path may be defined such that the liquid introduced from the inlet flows through the through hole, and after flowing to an outer surface side of the ceramic body at a forward end side of the ceramic body, the liquid turns around on a wall surface of the internal space to flow toward a rear end side, and flows along an outer surface of the ceramic body to the outlet, and the target flow path may be defined by at least a portion of the flow path, the portion extending from the forward end of the ceramic body to the outlet.

According to this liquid heating device, the present disclosure can be applied to a mode in which the liquid is caused to flow through the through hole of the ceramic body.

In the liquid heating device of the present disclosure, an axial center of an open end of the outlet through which the outlet faces the internal space may intersect with the axial-line direction, and a cutout portion which is continuous in a circumferential direction may be formed in a portion of the heat radiation fin, which portion overlaps the open end in the axial-line direction.

In the case where the axial center of the outlet intersects with the axial-line direction, the liquid having flowed in the axial-line direction along the heat radiation fin is required to change its flow direction such that the flow direction intersects with the axial-line direction.

Since the cutout portion is provided, it becomes easier for the liquid having flowed along the heat radiation fin to change its flow direction to a direction intersecting with the axial-line direction, whereby the efficiency can be improved further.

In the liquid heating device of the present disclosure, the heat radiation fin may be attached in such a manner as to cover not only the outer surface of the ceramic body but also a wall surface of the through hole of the ceramic body.

It is possible to suppress overheating of the heater from the wall surface of the through hole of the ceramic body as well by causing the liquid to flow through the through hole of the ceramic body. Furthermore, it is possible to heat the liquid from the wall surface of the through hole as well by the heat radiation fin, thereby further improving the efficiency in heating the liquid to be heated.

The present disclosure makes it possible to provide a ceramic heater and a liquid heating device which can improve heating efficiency without hindering the flow of a liquid to be heated.

Additional features and advantages of the present disclosure may be described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### BRIEF DESCRIPTION OF THE DRAWINGS

The figures contained herein are provided only by way of example and not by way of limitation.

FIG. 1 is a sectional view along an axial-line O direction of a liquid heating device according to an embodiment of the present disclosure.

FIG. 2 is an exploded perspective view showing the configuration of the liquid heating device.

FIG. 3 is a perspective view showing a ceramic heater.

FIG. 4 is a front view of the ceramic heater as viewed from its forward end.

FIG. 5 is a sectional view along line A-A in FIG. 3.

FIG. 6 is a perspective view showing the configuration of a ceramic body.

### DESCRIPTION OF REFERENCE NUMERALS

Reference numerals used to identify various features in the drawings include, but are not limited to, the following:
10 ceramic body
10h through hole
13 heat generation resistor element
20, 21, 22 heat radiation fin
21n cutout portion
100 ceramic heater
150 container
150i internal space
157 inlet
159 outlet
159e open end of the outlet
200 liquid heating device
O axial-line
W liquid
F flow path
Fs target flow path
DI flow direction in the target flow path
n2 axial center of the open end of the outlet

### DETAILED DESCRIPTION

Hereinafter, an embodiment of the present disclosure will be described.

It is to be understood that both the foregoing general description and the following detailed description are exemplary and are intended to provide further explanation of the claims. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

If used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus ≤10% of particular term, and “substantially” and “significantly” will mean plus or minus >10% of the particular term.

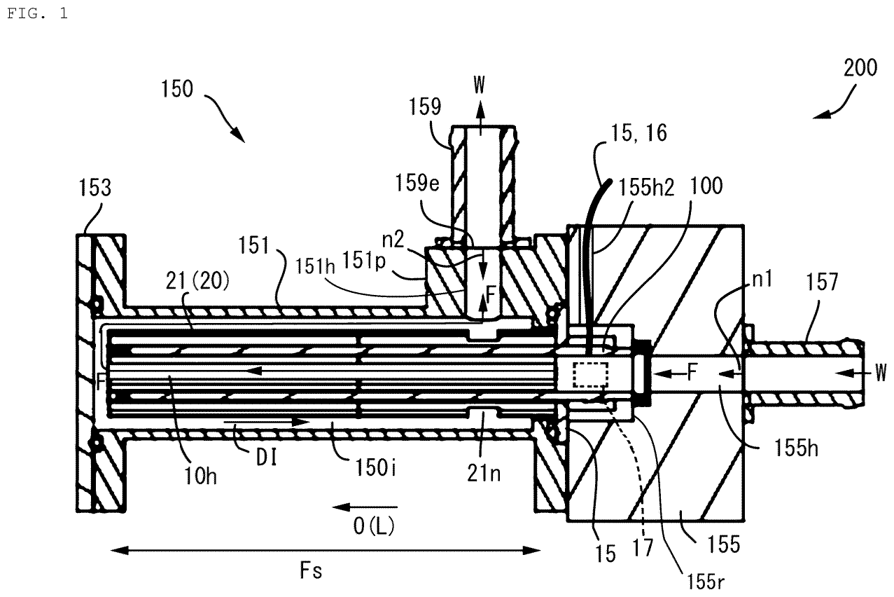

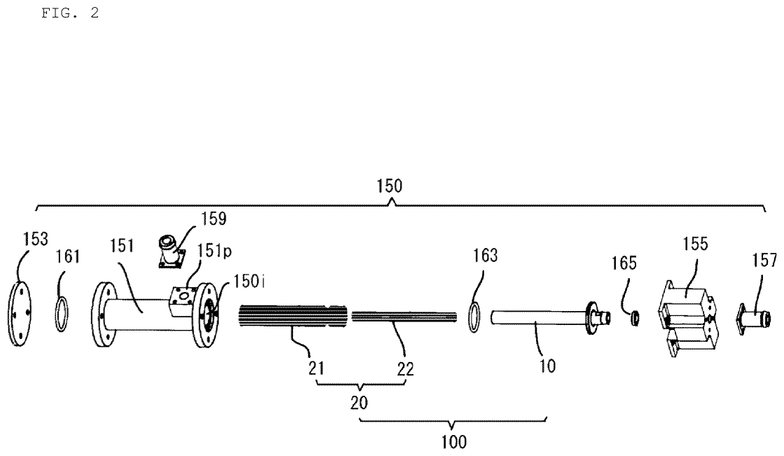

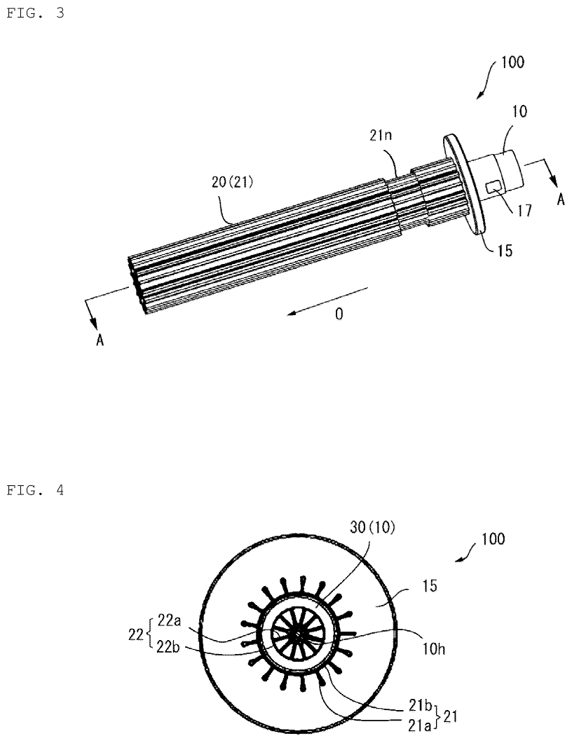

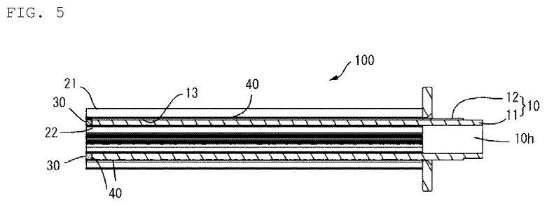

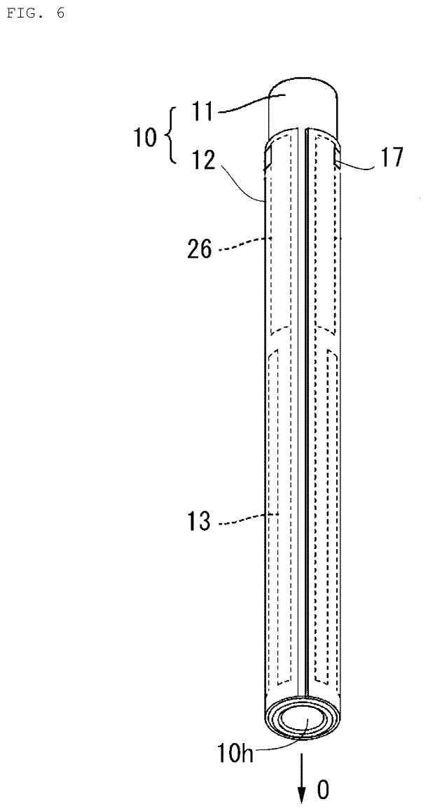

FIG. 1 is a sectional view along an axial-line O direction of a liquid heating device 200 according to an embodiment of the present disclosure. FIG. 2 is an exploded perspective view showing the configuration of the liquid heating device 200. FIG. 3 is a perspective view showing a ceramic heater 100. FIG. 4 is a front view of the ceramic heater 100 as viewed from its forward end. FIG. 5 is a sectional view along line A-A in FIG. 3. FIG. 6 is a perspective view showing the configuration of the ceramic body 10.

The liquid heating device 200 of this embodiment includes the ceramic heater 100 and can be used for air conditioning of, for example, an electric vehicle, heating and temperature keeping of a battery, or the like. The ceramic heater 100 is adapted for liquid heating and heats a liquid such as coolant liquid, thereby heating an object to be heated via the liquid.

As shown in FIG. 1 and FIG. 2, the liquid heating device 200 has substantially a cylindrical shape extending in axial direction L in its entirety, and has a container 150 and one ceramic heater 100.

The container 150 has a cylindrical trunk portion 151 having an internal space 150i for storing a liquid W (water), a front-end lid 153 and a rear-end lid 155 that respectively close openings at both ends in the axial direction of the trunk portion 151, and an inlet 157 and an outlet 159 for the liquid W.

Notably, in the present example, the direction toward the rear-end lid 155 along the axial direction L will be referred to as the “rear end side.”

Both ends in the axial direction L of the trunk portion 151 protrude in a flange shape in the radial direction. Both ends of the trunk portion 151, and the front-end lid 153 and the rear-end lid 155, are shown as being respectively sealed with each other in an airtight state by O rings 161, 163 (FIG. 2).

The rear-end lid 155 is formed into a generally block-like shape and has a penetration hole 155h which penetrates the rear-end lid 155 in the axial direction L. A cylindrical inlet 157 may be attached, via an O ring (not shown), to a rear end side of the rear-end lid 155 such that the inlet 157 communicates with the penetration hole 155h. Notably, the inlet 157 extends along the axial direction L.

The trunk portion 151 has a protruding portion 151p provided on the upper surface of a portion of the trunk portion 151 on the rear end side and has a rectangular box like shape. The protruding portion 151p has a through hole 151h which penetrates the protruding portion 151p in a direction perpendicular to the axial direction L and communicates with an internal space 150i. A cylindrical outlet 159 may be attached, via an O ring (not shown), to an upper surface of the protruding portion 151p such that the outlet 159 communicates with the through hole 151h. Notably, the outlet 159 extends in a direction perpendicular to the axial direction L.

The ceramic heater 100 has the shape of a column (tube) extending in the axial-line O direction. A flange portion 15 (see FIG. 3) provided on the rear end side of the ceramic heater 100 is held between the trunk portion 151 and the rear-end lid 155, whereby the ceramic heater 100 is attached to the container 150 in a cantilever fashion. A heat generation resistor element 13 (see FIG. 5) on the forward end side of the ceramic heater 100 is located in the internal space 150i.

Notably, a recess 155r which accommodates a rear-end-side portion of the ceramic heater 100 and communicates with the penetration hole 155h is formed on the forward end side of the rear-end lid 155. Lead wires 15 and 16 (which will be described later) for supplying electric power from the outside are connected to external terminals 17 (see FIG. 3) of the ceramic heater 100, and the lead wires 15 and 16 extend to the outside through a lead hole 155h2 which communicates with the recess 155r and penetrates the rear-end lid 155 upwardly.

The inlet 157 and the outlet 159 communicate with the internal space 150i and are located apart from each other in the axial direction L (also corresponding to the axial-line O direction). The liquid W introduced through the inlet 157 from outside passes through the internal space 150i along a flow direction F and then is discharged from the outlet 159.

A gap is formed between the inner wall of the container 150 and the ceramic heater 100. The liquid W introduced into the internal space 150i through the inlet 157 contacts with the outer surfaces of the ceramic heater 100 along the flow direction F, thus being heated, and then the liquid W flows through a flow path leading to the outlet 159.

Notably, in the present example, the ceramic heater 100 has a through hole 10h along the axial-line O direction, and the above-mentioned flow path is defined such that the liquid introduced through the inlet 157 flows through the through hole 10h, and, after having flowed to the outside of the ceramic heater 100 from the forward end of the through hole 10h, the liquid turns around the wall surface of the internal space 150i to flow toward the rear end side, and flows along the outer surface of the ceramic heater 100 to the outlet 159.

In order that the liquid W is introduced into the through hole 10h, the surface of the ceramic heater 100 which faces toward the rear end may be abutted on the penetration hole 155h of the rear-end lid 155 via an O ring 165. Thus, one end of the through hole 10h (on the rear end side) communicates with the inlet 157 in a state in which a liquid tight seal is established between the through hole 10h and the penetration hole 155h.

In addition, since the other end of the through hole 10h (on the forward end side) faces the internal space 150i, the liquid W having passed through the through hole 10h flows into the internal space 150i.

Notably, in the present example, the ceramic heater 100 is accommodated in the internal space 150i in such a manner that the axial direction L of the liquid heating device 200 (the trunk portion 151) becomes parallel to the axial-line O direction of the ceramic heater 100. However, the axial direction L may incline with respect to the axial-line O direction so long as the flow direction F in a target flow path, which will be described later, has an inclination angle of less than 45 degrees with respect to the axial-line O direction.

Next, the structure of the ceramic heater 100 will be described with reference to FIGS. 3 to 6.

As shown in FIG. 3, the ceramic heater 100 includes a circular columnar ceramic body 10 extending in the axial-line O direction, and heat radiation fins 20 attached in such a manner that the heat radiation fins 20 protrude from the surface of the ceramic body 10 in the radial direction and extend along the surface of the ceramic body 10 in the axial-line O direction. Notably, in the present example, the heat radiation fins 20 cover the surfaces of the ceramic body 10. In the present example, a plurality of the heat radiation fins 20 are disposed such that they are separated from one another in the circumferential direction of the ceramic body 10.

The heat radiation fins 20 may be formed of a material whose thermal conductivity is higher than that of the ceramic body, and, for example, a metal such as aluminum may be used.

The heat generation resistor element 13 is embedded in the ceramic body 10 (FIG. 5).

The term “circular column” encompasses “cylinder.”

A pair of external terminals 17 (only one external terminal is shown in FIG. 3) for supplying electricity to the heat generation resistor element 13 are exposed on the outer surface of a portion of the ceramic body 10 on the one end side (the rear end side).

An annular flange portion 15 formed of a ceramic material and used for attaching the ceramic heater 100 to an object (in the present example, a container 150), to which the ceramic heater 100 is to be attached, is fitted onto a portion of the ceramic body 10, which portion is located slightly forward of the external terminals 17. The flange portion 15 may be fixed to that portion of the ceramic body 10 by glass or the like.

The heat radiation fins 20 cover the surfaces of the ceramic body 10 on the forward end side of the flange portion 15.

As shown in FIGS. 4 and 5, in the present example, the ceramic body 10 has a cylindrical shape and has the through hole 10h at its center. The liquid flowing inside the through hole 10h is heated by the ceramic heater 100, and the liquid on the outer peripheral side of the ceramic heater 100 is also heated by the ceramic heater 100.

The heat radiation fins 20 may be composed of a first heat radiation fin 21 which covers the outer surface of the ceramic body 10 and a second heat radiation fin 22 which covers the inner surface of the ceramic body 10 (the wall surface of the through hole 10h).

An end surface (surface facing toward the forward end) of the ceramic body 10 is shown covered with a waterproof cap 30 which may be formed of a material having a higher thermal conductivity than the ceramic body 10, such as an aluminum alloy or a copper alloy.

A plurality of the heat radiation fins 20 (the first heat radiation fin 21 and the second heat radiation fin 22) are disposed such that they are separated from one another in the circumferential direction of the ceramic body 10 and extend in the axial-line O direction.

A cutout portion 21n which is continuous in the circumferential direction may be formed in a portion of the first heat radiation fin 21, the portion being located on the flange portion 15 side along the axial-line O direction. It is sufficient that the diameter of the cutout portion 21n is smaller than the diameter of the remaining portion of the first heat radiation fin 21. In the present example, fins extending in the axial-line O direction are formed on the outer surface of the cutout portion 21n. However, a structure in which no fin is formed on the outer surface of the cutout portion 21n may be employed.

The action of the cutout portion 21n will be described later.

The first heat radiation fin 21 has a cylindrical base portion 21b extending along the outer surface of the ceramic body 10 and a plurality of fin portions 21a integrally provided on the base portion 21b such that the fin portions 21a protrude outward from the outer surface of the base portion 21b. The fin portions 21a are disposed such that they are separated from one another in the circumferential direction of the base portion 21b.

Similarly, the second heat radiation fin 22 has a cylindrical base portion 22b extending along the inner surface of the ceramic body 10 and a plurality of fin portions 22a integrally provided on the base portion 22b such that the fin portions 22a protrude toward the center from the inner surface of the base portion 22b. The fin portions 22a are disposed such that they are separated from one another in the circumferential direction of the base portion 22b, and a gap is formed between distal ends of each pair of fin portions 22a located on opposite sides with respect to the center of the through hole 10h whereby an opening is formed at the center.

Notably, the heat radiation fins 20 (the first heat radiation fin 21 and the second heat radiation fin 22) may have configurations in which the heat radiation fin does not have the base portion and individual fin portions are attached directly to the surface of the ceramic body 10.

Each of the gap between the first heat radiation fin 21 and the outer surface of the ceramic body 10, the gap between the second heat radiation fin 22 and the inner surface of the ceramic body 10, and the gap between the waterproof cap 30 and the first heat radiation fin 21 and the second heat radiation fin 22 is fixedly sealed by a liquid-tight seal member 40 (for example, epoxy resin), whereby liquid tightness is maintained at these gaps.

The seal member 40 may be formed of a material other than resin, such as thermal conductive grease, so long as liquid tightness can be secured.

Next, the structure of the ceramic body 10 will be described with reference to FIG. 6.

The ceramic body 10 includes a ceramic tube 11 and a ceramic layer (ceramic sheet) 12 which covers almost the entirety of the outer circumference of the ceramic tube 11.

The heat generation resistor element 13 having a meandering shape and a pair of internal terminals 26 are formed on the inner circumferential surface (surface on the side toward the ceramic tube 11) of the ceramic layer 12 or are formed in the ceramic layer 12. The internal terminals 26 are electrically connected to the external terminals 17 at the end of the outer circumferential surface of the ceramic layer 12 through unillustrated via conductors or the like.

The heat generation resistor element 13 is disposed in a region near the forward end of the ceramic body 10, and the external terminals 17 are disposed on the rear end side of the ceramic body 10.

The ceramic tube 11 and the ceramic layer 12 may be formed of, for example, alumina.

As having been described above, in the ceramic heater 100 according to the embodiment of the present disclosure, the heat radiation fins 20 cover the surfaces of the ceramic body 10. Therefore, even if the heater is in a state of heating without liquid (air heating state) and the surface of the ceramic heater 100 becomes hot, liquid droplets do not come into direct contact with the hot portion and are cooled by the heat radiation fins 20. Therefore, it is possible to prevent generation of a crack or the like in the heater due to thermal shock, which would otherwise cause breakage of the heater.

In addition, since the ceramic heater 100 itself is cooled by the heat radiation fins 20, overheating of the ceramic heater 100 can be suppressed.

In the present example, the entire surfaces (front and back surfaces) of the ceramic body 10 are covered with the heat radiation fins 20 (the fin portions 21a and 22a and the base portions 21b and 22b), and the sealing member 40 which can maintain liquid tightness between the surfaces (front and back surfaces) of the ceramic body 10 and the heat radiation fins 20 is further provided.

Thus, it is possible to prevent the liquid from entering the gaps between the ceramic body 10 and the heat radiation fins 20, thereby preventing boiling of the liquid in the gaps, which would otherwise cause overheating of the heater.

Furthermore, in the ceramic heater 100 according to the embodiment of the present disclosure, a plurality of the heat radiation fins 20 (the first heat radiation fin 21 and the second heat radiation fin 22) are disposed such that they are separated from one another in the circumferential direction of the ceramic body 10 and extend in the axial-line O direction.

In addition, as shown in FIG. 1, the ceramic heater 100 is disposed in the internal space 150i of the container 150 in such a manner that the flow direction DI in the target flow path Fs has an inclination angle of less than 45 degrees with respect to the axial-line O direction.

As a result, the flow direction DI of the liquid W around the ceramic heater 100 approximately coincides with the direction in which the heat radiation fins 20 (21 and 22) extend (=the axial-line O direction). Thus, the liquid W flows smoothly along the heat radiation fins 20 without resistance. Therefore, it is possible to improve the efficiency in heating the liquid to be heated, without hindering the flow of the liquid W around the ceramic heater 100.

Here, as shown in FIG. 1, a path along which the liquid W introduced from the inlet 157 of the container 150 flows through the internal space 150i to the outlet 159 will be referred to as a “flow path F.”

The flow path F is composed of a path of the shortest distance which passes through the axial center n1 of an open end of the inlet 157 through which the inlet 157 faces the internal space 150i and the centroid of the through hole 10h of the ceramic heater 100 located in the internal space 150i, and a path of the shortest distance which extends from the forward end of the through hole 10h through the internal space 150i (the gap between the outer surface of the ceramic heater 100 and the wall surface of the container 150) and passes through the axial center n2 of an open end 159e of the outlet 159 through which the outlet 159 faces the internal space 150i.

Notably, the open end of the inlet 157 and the open end of the outlet 159 are the boundary between the container 150 and the inlet 157 and the boundary between the container 150 and the outlet 159, respectively, and are portions through which the inlet 157 and the outlet 159 face the internal space 150i.

The target flow path Fs is a portion of the flow path F, which the heat radiation fins 20 (the first heat radiation fin 21 and the second heat radiation fin 22) face.

The flow direction DI is the flow direction of the liquid in the target flow path Fs.

When the flow direction DI in the target flow path Fs of the container 150 has an inclination angle of 45 degrees or greater with respect to the axial-line O direction of the ceramic heater 100 (not shown), the flow direction DI does not approximately coincide with the direction in which the heat radiation fins 20 (21 and 22) extend (=the axial-line O direction). Thus, the liquid W does not flow smoothly along the heat radiation fins 20, and the flow is hindered.

The angle between the flow direction DI and the axial-line O direction is preferably 30 degrees or smaller.

In this example of the liquid heating device 200, the axial center n2 of the outlet 159 intersects with the axial-line O direction, and the cutout portion 21n is formed in a portion of the heat radiation fins 20 (the first heat radiation fin 21) that overlaps the open end 159e in the axial-line O direction.

In the case where the axial center n2 of the outlet 159 intersects with the axial-line O direction, the liquid W having flowed in the axial-line O direction along the first heat radiation fin 21 is required to change its flow direction such that the flow direction intersects with the axial-line O direction.

Since the cutout portion 21n is provided, it becomes easier for the liquid W having flowed along the first heat radiation fin 21 to change its flow direction to a direction intersecting with the axial-line O direction, whereby the efficiency in heating the liquid to be heated can be improved further.

In this example of the liquid heating device 200, the heat radiation fins 21, 22 are attached in such a manner as to cover not only the outer surface of the ceramic body 10 but also a wall surface of the through hole 10h of the ceramic body 10.

By virtue of this, it is possible to suppress overheating of the heater from the wall surface of the through hole 10h of the ceramic body 10 as well by causing the liquid W to flow through the through hole 10h of the ceramic body 10. Furthermore, it is possible to heat the liquid W from the wall surface of the through hole 10h as well by the heat radiation fin 22, thereby further improving the efficiency in heating the liquid to be heated.

It should be understood that the present disclosure is not limited to the above embodiment and incorporates various modifications and equivalents within the idea and the scope of the present disclosure.

No limitation is imposed on the shapes of the liquid heating device, the ceramic heater, the heat radiation fins, etc.

The heat radiation fins 20 can be manufactured by, for example, drawing of an aluminum material or press work in which fin portions are cut and raised from a metal plate.

The disclosure has been described in detail with reference to the above embodiments. However, the disclosure should not be construed as being limited thereto. It should further be apparent to those skilled in the art that various changes in form and detail of the disclosure as shown and described above may be made. It is intended that such changes be included within the spirit and scope of the claims appended hereto.

This application is based on Japanese Patent Application No. 2024-043168 filed Mar. 19, 2024 and Japanese Patent Application No. 2024-180510 filed Oct. 16, 2024, the disclosures of which are incorporated herein by reference their entirety.

What is claimed is:

1. A ceramic heater for liquid heating, comprising:
a columnar ceramic body extending in an axial-line direction and including a heat generation resistor element; and
a heat radiation fin which protrudes from a surface of the ceramic body and is higher in thermal conductivity than the ceramic body,
wherein the heat radiation fin extends in the axial-line direction.

2. A ceramic heater according to claim 1, wherein a plurality of the heat radiation fins are disposed such that they are separated from one another in a circumferential direction of the ceramic body.

3. A ceramic heater according to claim 1, wherein the heat radiation fins is composed of a first heat radiation fin that covers an outer surface of the ceramic body and a second heat radiation fin that covers an inner surface of the ceramic body, the inner surface corresponding to a through hole of the ceramic body along the axial-line direction.

4. A liquid heating device comprising:
a container having an internal space and having an inlet and an outlet which communicate with the internal space; and
the ceramic heater recited in claim 1, which extends in the axial-line direction, and in which the heat generation resistor element is located in the internal space,
wherein, in a flow path through which a liquid introduced from the inlet flows through the internal space to the outlet, the liquid is heated by the ceramic heater,
the heat radiation fin faces at least a portion of the flow path, and
when a portion of the flow path which the heat radiation fin faces is defined as a target flow path, a flow direction of the liquid in the target flow path has an inclination angle of less than 45 degrees with respect to the axial-line direction.

5. A liquid heating device comprising:
a container having an internal space and having an inlet and an outlet which communicate with the internal space; and
the ceramic heater recited in claim 2, which extends in the axial-line direction, and in which the heat generation resistor element is located in the internal space,
wherein, in a flow path through which a liquid introduced from the inlet flows through the internal space to the outlet, the liquid is heated by the ceramic heater,
the heat radiation fin faces at least a portion of the flow path, and
when a portion of the flow path which the heat radiation fin faces is defined as a target flow path, a flow direction of the liquid in the target flow path has an inclination angle of less than 45 degrees with respect to the axial-line direction.

6. A liquid heating device comprising:
a container having an internal space and having an inlet and an outlet which communicate with the internal space; and
the ceramic heater recited in claim 3, which extends in the axial-line direction, and in which the heat generation resistor element is located in the internal space,
wherein, in a flow path through which a liquid introduced from the inlet flows through the internal space to the outlet, the liquid is heated by the ceramic heater,
the heat radiation fin faces at least a portion of the flow path, and
when a portion of the flow path which the heat radiation fin faces is defined as a target flow path, a flow direction of the liquid in the target flow path has an inclination angle of less than 45 degrees with respect to the axial-line direction.

7. A liquid heating device according to claim 4, wherein
the ceramic body has a through hole along the axial-line direction,
the through hole communicates, through its one end, with the inlet and faces the internal space through its other end,
the flow path is defined such that the liquid introduced from the inlet flows through the through hole, and after flowing to an outer surface side of the ceramic body at a forward end side of the ceramic body, the liquid turns around on a wall surface of the internal space to flow toward a rear end side, and flows along an outer surface of the ceramic body to the outlet, and
the target flow path is defined by at least a portion of the flow path, the portion extending from the forward end of the ceramic body to the outlet.

8. A liquid heating device according to claim 4, wherein an axial center of an open end of the outlet through which the outlet faces the internal space intersects with the axial-line direction, and
a cutout portion which is continuous in a circumferential direction is formed in a portion of the heat radiation fin, which portion overlaps the open end in the axial-line direction.

9. A liquid heating device according to claim 7, wherein the heat radiation fin is attached in such a manner as to cover not only the outer surface of the ceramic body but also a wall surface of the through hole of the ceramic body.
